(19) United States
(12) Patent Application Publication
(10) Pub. No.: US 2012/0092320 A1
(43) Pub. Date: Apr. 19, 2012

(54) LIQUID CRYSTAL DISPLAY DRIVING DEVICE FOR IMPROVING POWER ON DELAY, TIMING CONTROL CIRCUIT, AND RELATED METHOD

(76) Inventors: Hung-Chun Li, Taipei County (TW); Mu-Shan Liao, Changhua County (TW); Tung-Hsin Lan, Taipei City (TW)

(21) Appl. No.: 13/023,548

(22) Filed: Feb. 9, 2011

(30) Foreign Application Priority Data
Oct. 14, 2010 (TW) 099135040

(51) Int. Cl. G09G 3/36; G06F 3/038

(52) U.S. Cl. 345/211; 345/87

(57) ABSTRACT

A liquid crystal display driving device for improving power on delay includes a gate driving circuit, a source driving circuit, and a timing control circuit. The timing control circuit is coupled to the gate driving circuit for transmitting a low-frequency frame rate lower than a normal frame rate of the liquid crystal display to operate the gate driving circuit for a predetermined number of clock cycles when a liquid crystal display powers on. Then, adjust the low-frequency frame rate to the normal frame rate of the liquid crystal display according to a trigger signal of the timing control circuit. And operate the liquid crystal display according to the normal frame rate.

### BACKGROUND OF THE INVENTION

1. Field of the Invention

The present invention is related to a liquid crystal display driving device and method thereof, and particularly to a liquid crystal display driving device for improving power on delay and method thereof.

2. Description of the Prior Art

Please refer to FIG. 1. FIG. 1 is a diagram illustrating a shift register 100 of a gate driving circuit according to the prior art. As shown in FIG. 1, a power on signal STV of a liquid crystal display is inputted to an input terminal IN1 of the register 100 of the gate driving circuit. When the power on signal STV of the liquid crystal display is a high voltage (that is, the liquid crystal display powers on), a thin film transistor T1 is turned on, resulting in a node N1 starting to be charged and a thin film transistor T2 being turned on. Meanwhile, a clock signal CK inputted to an input terminal CK1 is a low voltage, so a signal of an output terminal OUT of the shift register 100 (a voltage of a source terminal of the thin film transistor T2) is also a low voltage. When the clock signal CK is changed to a high voltage, the thin film transistor T2 is still turned on because the node N1 is still charged, resulting in a voltage of the node N1 being boosted due to a boost capacitor C1 coupling the high voltage of the clock signal CK to the node N1, where the boost capacitor C1 is coupled between a gate terminal and the source terminal of the thin film transistor T2. Thus, because the thin film transistor T2 is still turned on, the high voltage of the clock signal CK is outputted through the source terminal of the thin film transistor T2, that is, the signal of the output terminal OUT of the shift register 100 is a high voltage.

However, the thin film transistor T2 not only drives a switch coupled to a pixel of a scan line but also sets a next stage shift register. Therefore, a size of the thin film transistor T2 is very large for generating a larger driving current, and a parasitic capacitor of the thin film transistor T2 also increases with the size of the thin film transistor T2, resulting in a resistor-capacitor time constant of the node N1 being increased. Thus, at the beginning of powering on the liquid crystal display, the voltage of the node N1 is too low, which causes the power on delay.

### SUMMARY OF THE INVENTION

An embodiment provides a liquid crystal display driving device for improving power on delay. The liquid crystal display driving device includes a gate driving circuit, a source driving circuit, and a timing control circuit. The gate driving circuit includes a plurality of shift register, where a signal of an output terminal of each shift register of the gate driving circuit is used for controlling turning-on and turning-off of a switch coupled to a pixel. The source driving circuit is used for converting display data into a data voltage, then charging/discharging a corresponding pixel to a voltage corresponding to a gray level according to the data voltage. The timing control circuit is coupled to the gate driving circuit for transmitting a low-frequency frame rate lower than a normal frame rate of a liquid crystal display to operate the gate driving circuit for a predetermined number of clock cycles when the liquid crystal display powers on.

Another embodiment provides a timing control circuit applied to a liquid crystal display driving device for improving power on delay. The timing control circuit includes a timer, a trigger, and a frequency adjusting circuit. The timer is used for counting a predetermined number of clock cycles. The trigger is coupled to the timer for generating a trigger signal according to the predetermined number of clock cycles. The frequency adjusting circuit is coupled to the trigger for adjusting a low-frequency frame rate to a normal frame rate of a liquid crystal display according to the trigger signal.

Another embodiment provides a method for improving power on delay of a liquid crystal display. The method includes operating a gate driving circuit for a predetermined number of clock cycles according to a low-frequency frame rate lower than a normal frame rate of the liquid crystal display when the liquid crystal display powers on, adjusting the low-frequency frame rate to the normal frame rate of the liquid crystal display according to a trigger signal of a timing control circuit of the liquid crystal display, operating the liquid crystal display according to the normal frame rate.

The present invention provides a liquid crystal display driving device for improving power on delay, a timing control circuit, and a method for improving power on delay of a liquid crystal display. The liquid crystal display driving device, the timing control circuit, and the method utilize a frequency adjusting circuit to transmit a low-frequency frame rate lower than a normal frame rate of the liquid crystal display to operate a gate driving circuit when the liquid crystal display powers on. After the timer counts a predetermined number of clock cycles, the liquid crystal display operates according to the normal frame rate. Therefore, the present invention is capable of decreasing area of the gate driving circuit and reducing the power on delay.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a shift register of a gate driving circuit according to the prior art.

FIG. 2 is a diagram illustrating a liquid crystal display driving device for improving power on delay according to an embodiment.

FIG. 3 is a diagram illustrating the timing control circuit of the liquid crystal display driving device according to another embodiment.

FIG. 4 is a flowchart illustrating a method for improving power on delay of the liquid crystal display according to another embodiment.

### DETAILED DESCRIPTION

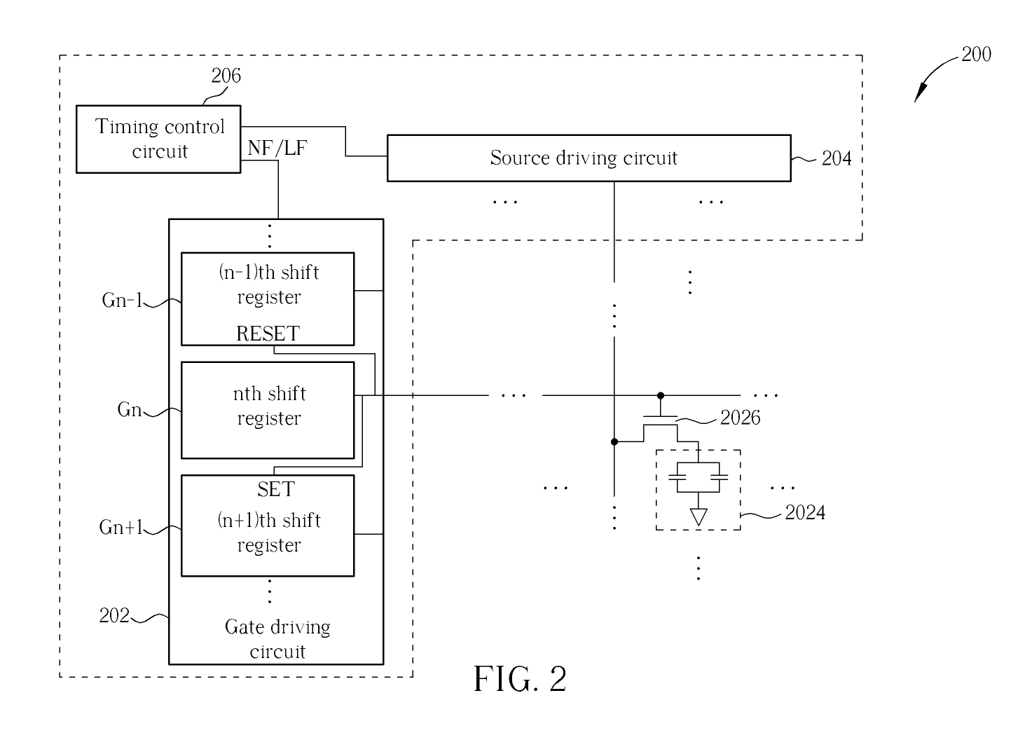

Please refer to FIG. 2. FIG. 2 is a diagram illustrating a liquid crystal display driving device 200 for improving power on delay according to an embodiment. The liquid crystal display driving device 200 includes a gate driving circuit 202, a source driving circuit 204, and a timing control circuit 206. The gate driving circuit 202 includes a plurality of shift register, and the plurality of shift registers are coupled together through output terminals thereof. For example, the plurality of shift registers include an (n−1)th shift register Gn−1, an nth shift register Gn, and an (n+1)th shift register Gn+1, which are coupled sequentially in the order shown in FIG. 2, where an output signal of the nth shift register Gn further acts as an input signal of a set terminal SET of the (n+1)th shift register Gn+1 and an input signal of a reset terminal RESET of the (n−1)th shift register Gn−1. A signal of an output terminal of each stage shift register is used for controlling turning-on and turning-off of a switch 2026 coupled to a pixel 2024. The source driving circuit 204 is used for converting display data into a data voltage, then charging/discharging a corresponding pixel 2024 to a voltage corresponding to a gray level according to the data voltage. The timing control circuit 206 is coupled to the gate driving circuit 202 and the source driving circuit 204 for transmitting a low-frequency frame rate LF lower than a normal frame rate NF of a liquid crystal display to operate the gate driving circuit 202 for a predetermined number of clock cycles CP.

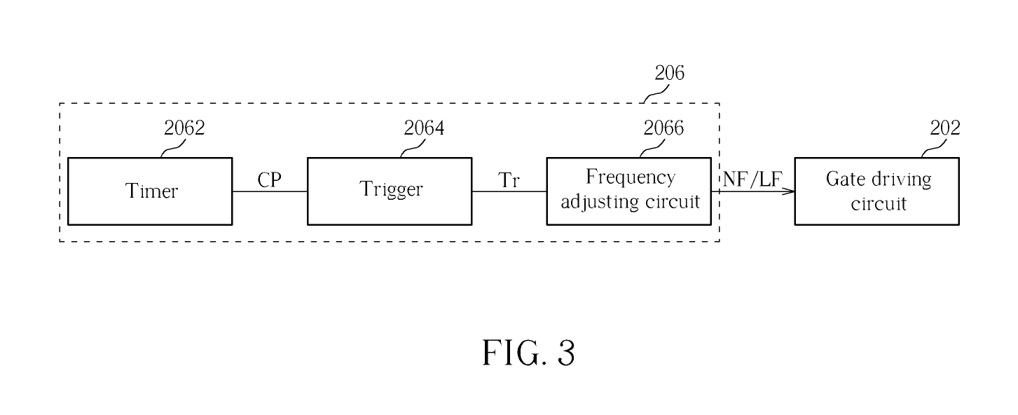

Please refer to FIG. 3. FIG. 3 is a diagram illustrating the timing control circuit 206 of the liquid crystal display driving device 200 according to another embodiment. The timing control circuit 206 includes a timer 2062, a trigger 2064, and a frequency adjusting circuit 2066. When the liquid crystal display powers on, the timing control circuit 206 first sets the liquid crystal display to enter a built-in self test (BIST) mode. Meanwhile, the frequency adjusting circuit 2066 of the timing control circuit 206 transmits the low-frequency frame rate LF lower than the normal frame rate NF of the liquid crystal display to operate the gate driving circuit 202. At the same time, the timer 2062 starts to count number of clock cycles and the timing control circuit 206 transmits black data to the source driving circuit 204, so the liquid crystal display displays a black frame. After the timer 2062 counts the predetermined number of clock cycles CP, the trigger 2064 coupled to the timer 2062 generates a trigger signal Tr according to the predetermined number of clock cycles CP. The frequency adjusting circuit 2066 coupled to the trigger 2064 adjusts the low-frequency frame rate LF to the normal frame rate NF of the liquid crystal display according to the trigger signal Tr, and the timing control circuit 206 starts to transmit normal data to the source driving circuit 204 for the liquid crystal display to display a normal frame.

Under a general condition, a current I flowing through an amorphous silicon thin film transistor is determined according to equation (1):

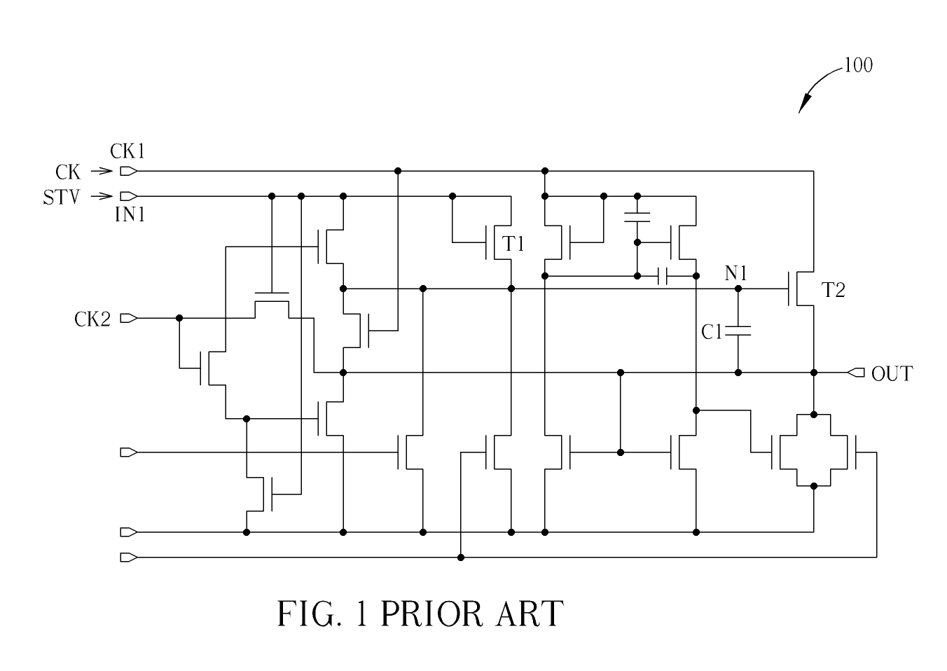

I=0.5×10⁻⁶×W/L (A) (1)

where W is width of the amorphous silicon thin film transistor and L is length of the amorphous silicon thin film transistor. Substituting the equation (1) into equation (2) yields equation (3):

$$\begin{matrix}I = \frac{d q}{d t} = C \frac{d V}{d t} & ( 2 ) \\ 0.5 \times {10}^{- 6} \times \frac{W}{L} \int d t = C \int d V & ( 3 )\end{matrix}$$

where V is a charging voltage of the boost capacitor C1 of FIG. 1, and C is a value of the boost capacitor C1 of FIG. 1. Equation (4) is generated by rearranging the equation (3):

$$\frac{W}{L} = \frac{2 VC}{{10}^{- 6} \times {t}_{w}} \qquad ( 4 )$$

where t_{w} is a charging time. Therefore, as shown in the equation (4), if the liquid crystal display powers on according to half the normal frame rate NF (that is, the charging time is 2*t_{w}), the width of the amorphous silicon thin film transistor is reduced ideally to half the width of the original amorphous silicon thin film transistor. But, the present invention is not limited to the liquid crystal display utilizing the half frame rate of the normal frame rate NF to power on. The liquid crystal display utilizing any frame rate lower than the normal frame rate NF to power on falls within the scope of the present invention.

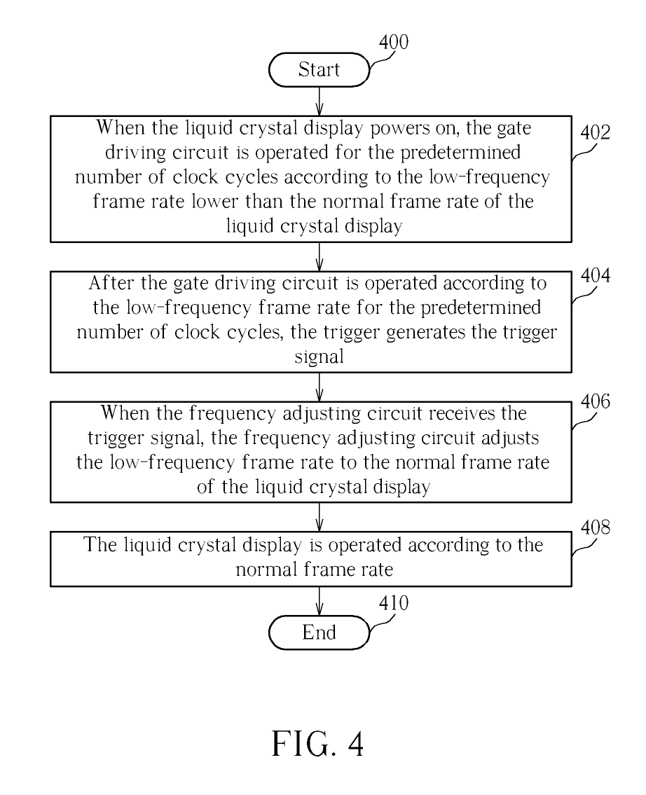

Please refer to FIG. 4. FIG. 4 is a flowchart illustrating a method for improving power on delay of the liquid crystal display according to another embodiment. FIG. 4 uses the liquid crystal display driving device 200 in FIG. 2 to illustrate the method. Detailed steps are as follows:

Step 400: Start.

Step 402: When the liquid crystal display powers on, the gate driving circuit 202 is operated for the predetermined number of clock cycles CP according to the low-frequency frame rate LF lower than the normal frame rate NF of the liquid crystal display.

Step 404: After the gate driving circuit 202 is operated according to the low-frequency frame rate LF for the predetermined number of clock cycles CP, the trigger 2064 generates the trigger signal Tr.

Step 406: When the frequency adjusting circuit 2066 receives the trigger signal Tr, the frequency adjusting circuit 2066 adjusts the low-frequency frame rate LF to the normal frame rate NF of the liquid crystal display.

Step 408: The liquid crystal display is operated according to the normal frame rate NF.

Step 410: End.

In Step 404, after the timer 2062 counts the predetermined number of clock cycles CP, the trigger 2064 coupled to the timer 2062 generates the trigger signal Tr according to the predetermined number of clock cycles CP. In Step 406, the frequency adjusting circuit 2066 coupled to the trigger 2064 adjusts the low-frequency frame rate LF to the normal frame rate NF of the liquid crystal display according to the trigger signal Tr. In Step 408, the liquid crystal display is operated according to the normal frame rate NF, and the timing control circuit 206 starts to transmit the normal data to the source driving circuit 204 for displaying a normal frame.

To sum up, the liquid crystal display driving device for improving power on delay, the timing control circuit, and the method for improving power on delay of the liquid crystal display utilize the frequency adjusting circuit to transmit the low-frequency frame rate lower than the normal frame rate of the liquid crystal display to operate the gate driving circuit when the liquid crystal display powers on, and the timing control circuit transmits the black data to the source driving circuit at the same time, so that the liquid crystal display displays the black frame in the meantime. After the timer counts the predetermined number of clock cycles, the frequency adjusting circuit adjusts the low-frequency frame rate to the normal frame rate of the liquid crystal display according to the trigger signal generated by the trigger, and the timing control circuit starts to transmit the normal data to the source driving circuit for the liquid crystal display to display a normal frame. Therefore, as shown in equation (4), if the liquid crystal display powers on according to the frame rate lower than the normal frame rate, the width of the amorphous silicon thin film transistor is decreased ideally due to the extended charging time, and the parasitic capacitor of the thin film transistor is also decreased. Therefore, the present invention is capable of decreasing area of the gate driving circuit and reducing the power on delay.

Those skilled in the art will readily observe that numerous modifications and alterations of the device and method may be made while retaining the teachings of the invention.

What is claimed is:

1. A liquid crystal display driving device for improving power on delay, the liquid crystal display driving device comprising:
a gate driving circuit comprising a plurality of shift registers;
a source driving circuit for converting display data into a data voltage, then charging/discharging a corresponding pixel to a voltage corresponding to a gray level according to the data voltage; and
a timing control circuit coupled to the gate driving circuit and the source driving circuit for transmitting a low-frequency frame rate lower than a normal frame rate of a liquid crystal display to operate the gate driving circuit for a predetermined number of clock cycles when the liquid crystal display powers on.

2. The liquid crystal display driving device of claim 1, wherein the timing control circuit comprises:
a timer for counting the predetermined number of clock cycles;
a trigger coupled to the timer for generating a trigger signal according to the predetermined number of clock cycles; and
a frequency adjusting circuit coupled to the trigger for adjusting the low-frequency frame rate to the normal frame rate of the liquid crystal display according to the trigger signal.

3. The liquid crystal display driving device of claim 2, wherein when the liquid crystal display operates according to the low-frequency frame rate, the timing control circuit further transmits black data to the source driving circuit.

4. The liquid crystal display driving device of claim 1, wherein a signal of an output terminal of each shift register of the gate driving circuit is used for controlling turning-on and turning-off of a switch coupled to a pixel.

5. The liquid crystal display driving device of claim 1, wherein a signal of an output terminal of an nth shift register further works as a set signal of an (n+1)th shift register and a reset signal of an (n−1)th shift register.

6. A timing control circuit applied to a liquid crystal display driving device for improving power on delay, the timing control circuit comprising:
a timer for counting a predetermined number of clock cycles;
a trigger coupled to the timer for generating a trigger signal according to the predetermined number of clock cycles; and
a frequency adjusting circuit coupled to the trigger for adjusting a low-frequency frame rate to a normal frame rate of a liquid crystal display according to the trigger signal.

7. The timing control circuit of claim 6, wherein when a liquid crystal display operates according to the low-frequency frame rate, the timing control circuit further transmits black data to a source driving circuit of the liquid crystal display.

8. A method for improving power on delay of a liquid crystal display, the method comprising:
operating a gate driving circuit for a predetermined number of clock cycles according to a low-frequency frame rate lower than a normal frame rate of the liquid crystal display when the liquid crystal display powers on;
adjusting the low-frequency frame rate to the normal frame rate of the liquid crystal display according to a trigger signal of a timing control circuit of the liquid crystal display; and
operating the liquid crystal display according to the normal frame rate.

9. The method of claim 8, wherein when the liquid crystal display operates according to the low-frequency frame rate, the timing control circuit further transmits black data to a source driving circuit of the liquid crystal display.
